(19) United States
(12) Patent Application Publication
(10) Pub. No.: US 2025/0162008 A1
(43) Pub. Date: May 22, 2025

(54) Urine treatment installation and method for treating urine using such an installation

(71) Applicant: ETTELIOT, NANTES (FR)

(72) Inventors: Alexandre EVRARD, NANTES (FR); Gustav SIEVERS, GREIFSWALD (DE)

(21) Appl. No.: 18/839,399

(22) PCT Filed: Feb. 16, 2023
(86) PCT No.: PCT/FR2023/050219

§ 371 Date: Aug. 16, 2024

(30) Foreign Application Priority Data
Feb. 17, 2022 (FR) 2201389
Feb. 17, 2022 (FR) 2201391

(51) Int. Cl. B09B 3/40; C02F 1/36; C02F 1/461; C02F 103/00

(52) U.S. Cl. CPC B09B 3/40; C02F 1/36; C02F 1/46109; C02F 2103/005; C02F 2201/46145; C02F 2209/001; C02F 2209/42

(57) ABSTRACT

A urine treatment Installation (1) has a fluid circulation circuit (2) with at least one inlet (3) for supplying urine to the circuit (2) and at least one outlet (4) from said circuit (2). The installation (1) has disposed on said circuit (2), at least one electrolyzer (5) equipped with at least one liquid outlet (52). The installation (1) further has, disposed on the circuit (2), at least: a tank serving to supply urine to the electrolyzer (5) and having the function at least of a buffer tank (7) in order to permit “batchwise” operation, that is to say batch feeding of the electrolyzer (5) from the buffer tank (7), and an ultrasound generator (6) positioned downstream of the electrolyzer (5) and in fluidic communication with the or at least one of the liquid outlets (52) of the electrolyzer (5).

The present invention relates to a urine treatment installation and to a method for treating urine using such an installation.

It relates in particular to a urine treatment installation that can be used as a substitute for a urinal or toilet, said urine treatment installation comprising a control unit and a fluid circulation circuit with at least one inlet for supplying urine to the circuit and with at least one outlet from said circuit, said installation comprising, disposed on said circuit, at least one electrolyzer equipped with at least one liquid outlet, and a tank serving to supply urine to the electrolyzer and having the function at least of a buffer tank in order to permit “batchwise” operation, that is to say batch feeding of the electrolyzer from said buffer tank, said buffer tank, in fluidic communication with the electrolyzer, being connected to the electrolyzer by at least one connection equipped with a pump capable of being controlled by the control unit.

Urine treatment installations have undergone development in recent years. These urine treatment installations can be in the form of what are called stand-alone installations, which may also serve as a substitute for a urinal or toilet. In this case, the urine treatment is carried out in situ, i.e. at or near the place where the urine is collected. The objective in terms of producing such a urine treatment installation is to limit the maintenance and the nuisance of such an installation. Until now, such installations offer electrolysis of the urine, which disinfects and deodorizes the urine at least partially. Electrolyzed urine is also called gray water. However, such a urine treatment installation has to be emptied frequently. This involves tedious maintenance.

The document U.S. Pat. No. 4,045,314 describes an installation offering treatment of excrement by electrolysis, followed by a step in which the result of the electrolysis is combusted. The design of this installation excludes any compact format and any cleaning of the installation because of the fact that the installation collects all of the excreta indiscriminately, with the result that the electrolytic treatment is lengthy, tedious and probably inefficient, and the result of the electrolysis is eliminated by evaporation. This also results in costs in terms of high energy consumption.

The document JP 2001-128886 describes a urine treatment installation requiring the combination of two ultrasound generators and a filter medium in the form of a honeycomb. Any cleaning of such an installation is ruled out.

Other treatments, in particular by electrodialysis, may be envisioned, as is illustrated in the document CN 111 170 579. Again, such a design excludes a compact format of the installation.

An object of the invention is to make available a urine treatment installation whose design makes it possible to limit the manual emptying of such an installation without impairing the compact nature of the installation and its ease of cleaning.

Another object of the invention is to make available a urine treatment installation designed to guarantee the quality of the treatment within a short time.

To this end, the subject matter of the invention is a urine treatment installation comprising a control unit and a fluid circulation circuit with at least one inlet for supplying urine to the circuit and with at least one outlet from said circuit, said installation comprising, disposed on said circuit, at least one electrolyzer equipped with at least one liquid outlet, and a tank serving to supply urine to the electrolyzer and having the function at least of a buffer tank in order to permit “batchwise” operation, that is to say batch feeding of the electrolyzer from said buffer tank, said buffer tank, in fluidic communication with the electrolyzer, being connected to the electrolyzer by at least one connection equipped with a pump capable of being controlled by the control unit, characterized in that the installation comprises an ultrasound generator positioned downstream of the electrolyzer and in fluidic communication with the or at least one of the liquid outlets of the electrolyzer, in that the ultrasound generator comprises a chamber and an ultrasonic nebulization apparatus housed inside said chamber, in that said chamber is equipped with at least one device for forced circulation of fluid, at least one outlet to ambient air and at least one liquid inlet in fluidic communication with the or at least one of the liquid outlets of the electrolyzer for supplying electrolyzed liquid urine to said chamber, in that said nebulization apparatus is configured to transform at least some of the electrolyzed liquid urine from the electrolyzer into a mist-like cloud of fine particles, and in that the device for forced circulation of fluid is configured to guide the movement of the produced mist in the direction of the or at least one of the outlets to ambient air of said chamber, and in that the pump of the connection between the buffer tank and the electrolyzer is a reversing pump.

The presence of a buffer tank and the design of the assembly formed by the buffer tank and the electrolyzer ensure the efficacy of the electrolytic treatment. In fact, the presence of a tank for supplying urine to the electrolyzer and having at least the function of a buffer tank permits a controlled supply of urine to the electrolyzer. In particular, the presence of a tank for supplying urine to the electrolyzer and having at least the function of a buffer tank permits “batchwise” operation, that is to say batch feeding of the electrolyzer. The discontinuous feeding of the electrolyzer with a predetermined maximum quantity by virtue of the presence of the buffer tank ensures a sufficient duration of treatment in the electrolyzer as regards the quantity of urine present in the electrolyzer. The effectiveness of the treatment is thus guaranteed. The presence of an ultrasound generator downstream of the electrolyzer makes it possible to produce, from the liquid part of the urine issuing from the electrolysis, a mist which can then be discharged into the atmosphere. Thus, the emptying of such an installation is reduced due to the removal of the liquid part of the electrolyzed urine in the form of a mist. The presence of a reversing pump, i.e. a pump with two directions of rotation, between the buffer tank and the electrolyzer permits easy cleaning of the installation by simple reversal of the direction of rotation of the pump.

Preferably, the device for forced circulation of fluid is a fan disposed in the or one of the outlets to ambient air of said chamber.

According to one embodiment of the invention, the electrolyzer is compartmentalized and comprises a first compartment housing electrodes and equipped with the liquid outlet of the electrolyzer, and a second compartment communicating with the first compartment on the one hand via an overflow and on the other hand via a pumping device. The realization of the electrolyzer in the form of at least two compartments, with the creation of a flow of fluid between the two compartments, makes it possible to improve the quality of the electrolysis treatment within a short time and to manage the problem of the foam that is created and results from the electrolysis treatment. This design also allows the gases produced to be evacuated directly to the ultrasound generator.

According to one embodiment of the invention, the electrolyzer comprises a level sensor, and the control unit is configured to control the reversing pump at least as a function of the data provided by the level sensor. Again, this arrangement ensures the efficacy and quality of the electrolytic treatment, the pump being stopped as soon as a predetermined level of urine is reached in the electrolyzer.

According to one embodiment of the invention, the control unit is configured to control the pumping device as a function of the data provided by the level sensor. Thus, the pumping device is started up as soon as liquid arrives in at least part of the electrolyzer, in order to guarantee the quality of the treatment. Preferably, the level sensor is configured to measure a liquid level within the second compartment of the electrolyzer. Thus, the level sensor is versatile and makes it possible to control, via the control unit, on the one hand the stopping of the pump arranged between the buffer tank and the electrolyzer and on the other hand the start-up of the pumping device of the electrolyzer. This functioning is optimized in terms of energy consumption, the pumping device only starting when the electrolyzer is filled with a predetermined minimum volume.

According to one embodiment of the invention, the electrolyzer is equipped with at least one gas outlet connected to the ultrasound generator. This affords the possibility of housing the electrolyzer and the ultrasound generator in the same casing without having to multiply the outlets of the casing.

According to one embodiment of the invention, the urine supply inlet of the circuit is equipped with a urine collector. This urine collector can take many forms. This urine collector can, for example, be in the form of a urinal or a toilet bowl. Thus, the treatment of the urine can be carried out as an extension of the collection of the urine. Alternatively, this urine collector can be in the form of one or more receptacles connectable to a urinal or to a toilet bowl.

According to one embodiment of the invention, the urine collector is a urinal or a feces/urine separator with a urine-collecting part and a feces-collecting part. Thus, urine and fecal matter can be processed in parallel.

According to one embodiment of the invention, the installation comprises a feces treatment unit.

According to one embodiment of the invention, the feces treatment unit comprises a dihydrogen production station connected at the inlet to the electrolyzer in order to enable electrolyzed urine to be supplied to the dihydrogen production station, and a feces combustion station operating on dihydrogen, that is to say comprising at least one dihydrogen burner, said feces combustion station being equipped with a connection connecting the feces combustion station to the feces-collecting part without passage through the electrolyzer. The urine treatment installation makes it possible to produce, from the urine, dihydrogen which is used for combustion of the feces arriving directly in the combustion station from the feces-collecting part. An installation is thus obtained in which, once again, the emptying operations can be reduced, the feces being reduced to ash within a very short treatment time and with guaranteed treatment efficacy.

Preferably, a siphon is disposed between the urine supply inlet of the circuit and the buffer tank. Such a siphon isolates the contents of the buffer tank from the outside in order to prevent odors from rising.

According to one embodiment of the invention, a non-return valve is disposed on the outlet to ambient air of the ultrasound generator.

The invention also relates to a method for treating urine in a urine treatment installation, characterized in that the urine treatment installation is in accordance with what has been described above, which method comprises, starting from the buffer tank, a step of supplying urine in a controlled manner to the electrolyzer by pumping, followed by a step of ultrasonically treating the electrolyzed urine coming from the electrolyzer.

According to one embodiment of the method, the inlet of the circuit of the installation is equipped with a urine collector in the form of a feces/urine separator, the step of supplying urine to the electrolyzer from the buffer tank being preceded by a step of separating the urine and feces.

### BRIEF DESCRIPTION OF THE DRAWINGS

The invention will be clearly understood on reading the following description of exemplary embodiments, with reference to the appended drawings in which:

FIG. 1 shows a schematic view of a urine treatment installation according to the invention;

FIG. 2 shows a schematic view of a urine treatment installation according to the invention, this urine treatment installation comprising a feces treatment unit;

FIG. 3 shows a schematic view of a urine treatment installation according to the invention;

FIG. 4 shows a schematic view of an electrolyzer of a urine treatment installation according to the invention;

FIG. 5 shows a schematic view of an ultrasound generator of a urine treatment installation according to the invention.

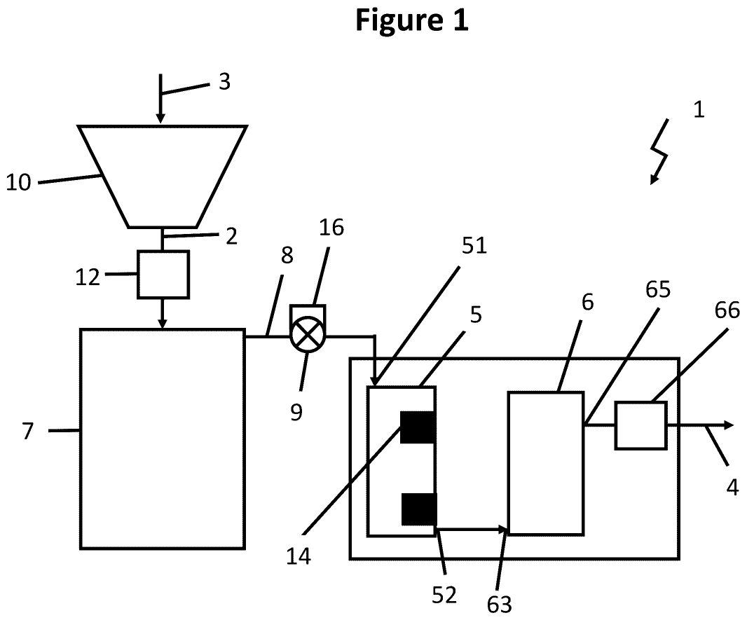

As has been mentioned above, the subject matter of the invention is a urine treatment installation 1 which may be of the type shown in FIGS. 1 to 3. This urine treatment installation 1 is more particularly intended to be installed in mobile structures, such as a camper van, in public transport, such as a bus or train, on construction sites, in autonomous light constructions or the like.

Such a urine treatment installation 1 makes it possible to do without a connection to the sewage system while at the same time requiring reduced maintenance. Such a urine treatment installation 1 may be a portable installation and may be connected to a urinal or a toilet bowl or directly incorporate the urinal and/or the toilet bowl, as will be described below.

Such a urine treatment installation 1 comprises a control unit 16 and a fluid circulation circuit 2 with at least one inlet 3 for supplying urine to the circuit 2 and with at least one outlet 4 from said circuit 2. This fluid circulation circuit 2 may be of greater or lesser length and of greater or lesser complexity, as is illustrated in the figures.

The installation 1 comprises, disposed on the fluid circulation circuit 2, at least one electrolyzer 5 equipped with at least one liquid outlet 52, at least one ultrasound generator 6 positioned downstream of the electrolyzer 5 and in fluidic communication with the or at least one of the liquid outlets 52 of the electrolyzer 5, and a tank serving to supply urine to the electrolyzer 5 and having the function of a buffer tank 7 in order to allow urine to be supplied from said buffer tank 7 to the electrolyzer 5 discontinuously in batches and according to a predetermined maximum quantity of urine.

It should be noted that the terms “upstream” and “downstream” are used with respect to the direction of flow of the liquid inside the circuit from the inlet to the outlet of the circuit.

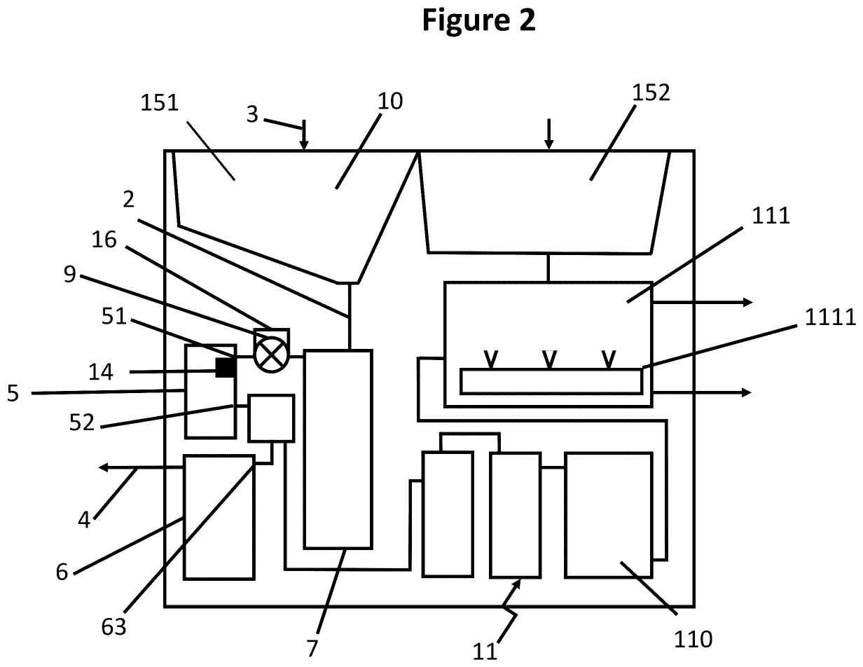

In the examples shown, the buffer tank 7 is supplied at the inlet directly from a urine collector 10 arranged at the inlet 3 of the circuit 2, as is illustrated in FIGS. 1 and 2. This urine collector 10 can comprise only one urine-collecting part and, for example, can be presented in the form of a urinal, as is illustrated in FIG. 1. This urine collector 20 can comprise a feces/urine separator with a urine-collecting part 151 and a feces-collecting part 152, as is illustrated in FIG. 2.

Generally, a siphon 12 is disposed between the urine supply inlet 3 of the circuit 2 and the buffer tank 7.

The buffer tank 7 into which the collected urine arrives is a buffer tank 7 intended to supply urine to the electrolyzer 5. The buffer tank 7 in fluidic communication with the electrolyzer 5 is connected to the electrolyzer 5 by one or more connections 8 that can be closed off depending on the design of the circuit 2. The buffer tank 7 therefore comprises at least one outlet and the electrolyzer comprises at least one inlet, and the outlet of the buffer tank 7 is connected to the inlet of the electrolyzer by a fluidic connection 8 equipped with a pump 9 capable of being controlled by the control unit 16.

The pump 9 can be controlled at predetermined time periods and/or as a function of data provided by sensors such as level sensors, which will be described below.

The connection 8 between the buffer tank 7 and the electrolyzer 5 is a bidirectional connection, because the pump 9 is a reversing pump and allows the passage of liquid from the buffer tank 7 to the electrolyzer 5 and, by reversal of the direction of operation of the pump 9, allows the passage of liquid from the electrolyzer 5 to the buffer tank 7. This possibility of reversing the direction of the pump 9 allows easy cleaning of the installation 1 while at the same time allowing discontinuous supply to the electrolyzer 5 from the buffer tank 7, that is to say in fractions or in batches. Thus, the electrolyzer 5 processes one batch of urine at each operation. The batches may or may not be identical from one batch to another.

In FIG. 1, which corresponds to the simplest version of the installation, the buffer tank 7, which is connected at the inlet to the urine collector 10, is connected directly at the outlet to the electrolyzer 5, in particular to an inlet 51 of the electrolyzer 5. This electrolyzer 5 is connected at the outlet, shown at 52 in the figures, to the ultrasound generator 6. A similar assembly is shown in FIG. 2.

The possibility of closing the connection between the electrolyzer 5 and the buffer tank 7 by means of the pump 9 makes it possible to monitor and possibly quantify the amount of urine fed into the electrolyzer and thus ensure a discontinuous supply, that is to say batchwise supply, of said electrolyzer. Thus, the electrolyzer 5, once supplied with urine, can treat the quantity of urine received, and then, once the treatment is completed, can empty itself before receiving a new batch of urine to be treated.

Independently of the design of the circuit 2, the electrolyzer 5 can be equipped with at least one level sensor 14. The presence of such a level sensor 14 once again makes it possible to guarantee that the electrolyzer is supplied with a quantity less than or equal to a predetermined maximum quantity of urine when this level sensor helps control the pump 9 of the closable connection 8 between the electrolyzer and the buffer tank 7.

In order to allow this supply of urine to the electrolyzer in a discontinuous manner, that is to say in batches, and according to a predetermined maximum quantity, the operating time of the pump 9 disposed on the connection 8 between the electrolyzer 5 and the buffer tank 7 can also be controlled precisely. In the examples shown, the pump 9, in particular the stopping of the pump 9, is controlled by the control unit 16 as a function of the data supplied by the level sensor 14 with which the electrolyzer 5 is equipped. Thus, as soon as the maximum level inside the electrolyzer 5 is reached, the pump 9 is stopped. The start-up of the pump 9 can be controlled by the control unit 16 as a function of the data supplied by a level sensor 21 disposed in the buffer tank 7.

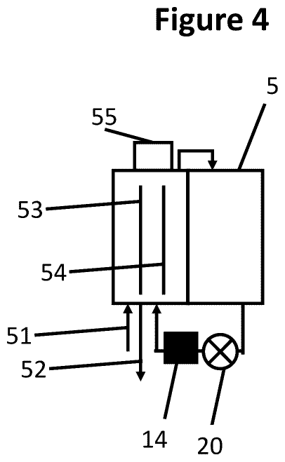

The electrolyzer 5, as shown in FIG. 4, comprises, in addition to the liquid inlet 51 and the liquid outlet 52, two electrodes, namely an anode 53 and a cathode 54. The anode 53 is preferably made of titanium and iridium, the cathode 54 of graphite or carbon or stainless steel or iron.

An electrical supply of the electrodes is provided, shown at 55 in FIG. 4. Generally, the electrolytic treatment is carried out with a voltage of between 2 and 12 volts. The duration of the treatment can be up to 20 minutes for a unit volume of 250 ml. The duration of the treatment depends on the current and potential that are selected. The electrolytic treatment of urine destroys all the enzymes and bacteria, disinfects the urine and oxidizes certain components of urine to nitrate, struvite or other degradation minerals.

Generally, the capacity of the buffer tank 7 is between 25 ml and 10 liters.

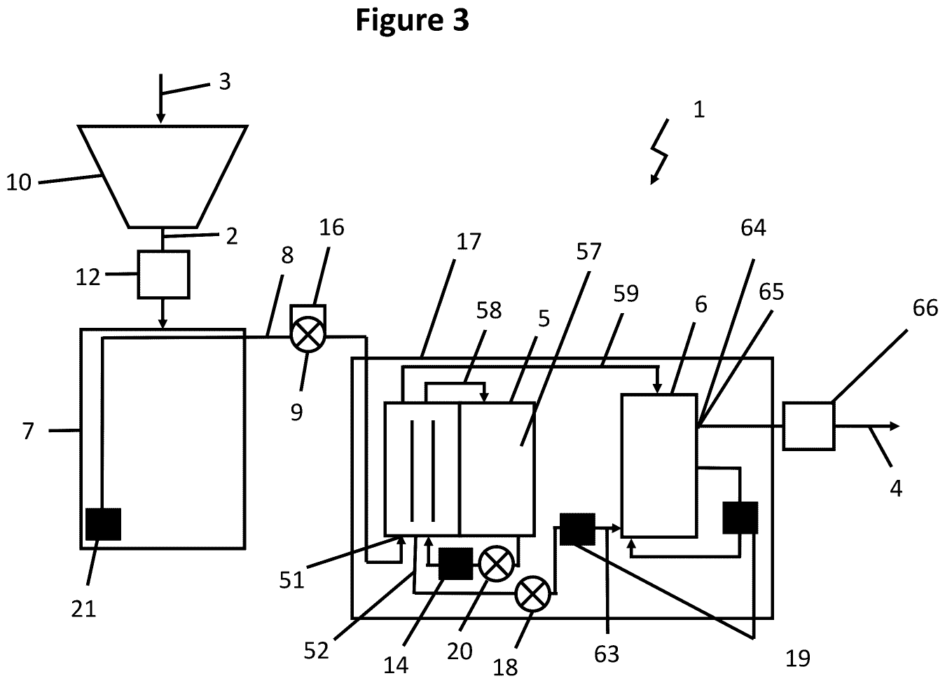

In the example shown, the maximum volume of urine to be treated by the electrolyzer 5 is equal to 25 ml. The duration of electrolytic treatment is 3 minutes. The electrolyzer 5 and the ultrasound generator 6 are housed inside a casing 17. This casing 17, which is generally parallelepipedal in shape, has dimensions of 20 cm×20 cm×12 cm. It is therefore extremely compact and, as is illustrated in FIG. 3, simply has a liquid inlet, an outlet for liquid in mist form, and a gas outlet. In the example shown in FIG. 3, the liquid and gas outlets are common.

In the example shown in FIG. 4, the electrolyzer 5 is compartmentalized and comprises a first compartment 56 housing electrodes 53, 54 and equipped with the liquid outlet 52 of the electrolyzer 5, and a second compartment 57 communicating with the first compartment 56 on the one hand via an overflow 58 and on the other hand via a pumping device 20. The level sensor 14 is also associated with the pumping device 20. Indeed, the control unit 16 is configured to control the pumping device 20 as a function of the data supplied by the level sensor 14. This makes it possible, via the control unit 16, to control in parallel the stopping of the pump 9 and the start-up of the pumping device 20 as a function of the data supplied by the level sensor 4. This level sensor 14 detects the level inside the second compartment 57 of the electrolyzer 5. The electrolyzer 5 is also equipped with at least one gas outlet 59 connected to the ultrasound generator 6. This gas outlet 59 equips the first compartment 56 of the electrolyzer 5.

In practice, to achieve the required treatment efficiency, a predetermined maximum quantity of urine is introduced into the electrolyzer 5 via the connection 8 between the buffer tank 7 and the electrolyzer 5. This predetermined maximum quantity is obtained by cooperation between the pump 9 and the level sensor 14 configured to detect the presence of liquid in the second compartment of the electrolyzer 5. Indeed, as soon as urine arrives in the buffer tank 7, it is detected by the level sensor 21, which triggers the operation of the pump 9. The pump 9 supplies urine to the first compartment 56 of the electrolyzer 5. As soon as this first compartment is filled, the urine enters the second compartment 57 of the electrolyzer 5 through the overflow 58. This arrival of liquid is detected by the level sensor 14 which stops the pump 9 and controls in parallel the start-up of the pumping device 20, which allows the return of liquid from the second compartment of the electrolyzer 5 to the first compartment of the electrolyzer 5. This circulation between the two compartments of the electrolyzer 5 increases the efficacy of the electrolytic treatment and reduces its duration. The treatment can thus be of the order of 3 minutes for a volume to be treated of the order of 25 ml.

At the end of a predetermined period of time, the electrolyzed urine is discharged from the electrolyzer 5 and reaches the ultrasound generator 6. Once this electrolyzed urine fraction has reached the ultrasound generator 6, a new fraction of urine can be introduced from the buffer tank 7 into the electrolyzer 5. The treatment is thus carried out in what is called a discontinuous manner because of the electrolyzer 5 being fed in a discontinuous manner with batches or fractions.

To permit transfer of electrolyzed urine from the first compartment of the electrolyzer 5 to the ultrasound generator 6, the installation 1 comprises a pump 18 disposed between the liquid outlet 52 of the electrolyzer 5 and the ultrasound generator 6. This pump 18, like the pumping device 20, is reversible in direction. The ultrasound generator 6 is equipped with level sensors shown at 19 in FIG. 3.

As is shown in FIG. 6, the ultrasound generator 6 comprises a chamber 62 and an ultrasound nebulization apparatus 61 housed inside the chamber 62. The nebulization apparatus 61 is configured to transform at least some of the electrolyzed liquid urine from the electrolyzer 5 into a cloud of fine particles of the mist type inside the chamber 62.

The chamber 62 is also equipped with a device 64 for forced circulation of air, such as a fan. This chamber also comprises at least one outlet 65 to ambient air and a liquid inlet 63 in fluidic communication with the or at least one of the liquid outlets 52 of the electrolyzer 5 for supplying electrolyzed liquid urine to said chamber 62, this electrolyzed liquid urine being transformed into a cloud of fine particles of the mist type by the nebulization apparatus 61.

The device 64 for forced circulation of fluid is configured to guide the movement of the produced mist toward the outlet 65 to the ambient air of said chamber, in order to allow dispersion of the produced mist into the atmosphere.

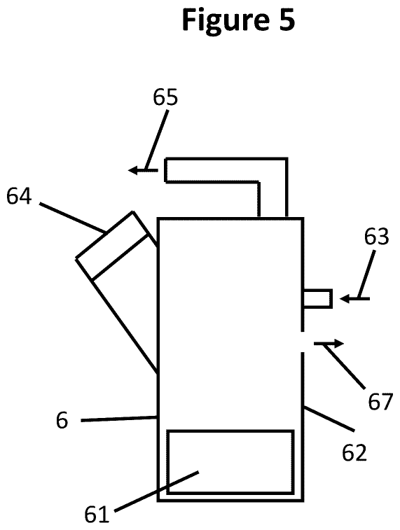

In the example shown in FIG. 5, the device 64 for forced circulation of fluid in the form of a fan is disposed in an opening to ambient air of the chamber, in order to suck in said external air and generate a flow of air inside the chamber. This flow of air entrains the mist, produced at the level of the ultrasound nebulization apparatus 61 disposed in the lower part of the chamber, in the direction of an outlet to ambient air of the chamber disposed in the upper part of the chamber, in order to allow this mist to disperse into the atmosphere. Thus, the ultrasound generator makes it possible to discharge into the atmosphere almost all of the electrolyzed urine coming from the electrolyzer and transferred into the ultrasound generator.

To complete the installation, a non-return valve 66 is disposed on the outlet 65 to ambient air of the ultrasound generator 6.

In order to achieve efficient nebulization, the quantity of liquid to be introduced into the ultrasound generator is controlled. Ideally, the electrolyzer and the ultrasound generator are dimensioned correspondingly, so that the maximum volume contained in the electrolyzer can be processed in one go by the ultrasound generator.

The supply of urine from the electrolyzer to the ultrasound generator can be effected directly by a direct fluidic link connecting the outlet 52 of the electrolyzer to the liquid inlet 63 of the chamber of the ultrasound generator 6, as is illustrated in FIG. 1 or in FIG. 3.

The supply of urine from the electrolyzer 5 to the ultrasound generator can be effected indirectly via an intermediate tank, as is illustrated in FIG. 2.

In a more complex version of the installation, as is illustrated in FIG. 2, the urine collector 10 can be made in the form of a feces/urine separator with a urine-collecting part 151 and a feces-collecting part 152. In this embodiment, the installation additionally comprises a feces treatment unit 11. The feces are collected at 152 in the installation 1 of FIG. 2 at the urine collector 10, which in this case is a separator of feces and urine.

In the other versions of the installation, this urine collector 10 can be in the form of a simple urinal, a toilet bowl or any other container allowing urine to be collected.

The feces treatment unit 11 comprises a dihydrogen production station 110 connected at the inlet to the electrolyzer 5 in order to allow electrolyzed urine to be supplied to the dihydrogen production station 110, and a feces combustion station 111 operating on dihydrogen, that is to say comprising at least one dihydrogen burner 1111, also called a hydrogen burner.

The fecal matter collected in the installation 1 at the level of the feces-collecting part 152 of the separator is introduced directly into the combustion station 111 without passing through the electrolyzer 5, in order to be burned in said station and converted into ash. In parallel, the collected urine is treated, as mentioned above, by passage through the electrolyzer 5 and the ultrasound generator 6 before being discharged in the form of a mist into the atmosphere. At the outlet of the electrolyzer, some of the electrolyzed urine is fed not to the ultrasound generator 6 but to the dihydrogen production station 110, after optional filtration of the electrolyzed urine, including, for example, passage through an ion exchanger.

This dihydrogen production station 110 is again an electrolyzer, but this electrolyzer is here a membrane electrolyzer.

The dihydrogen coming from this dihydrogen production station 110 feeds the burner of the combustion chamber where the fecal matter is converted into ash and collected in an ash receptacle, which is preferably extractable.

In practice, the method of treatment in a urine treatment installation 1, as described above, still comprises, starting from the buffer tank 7, a step of supplying the electrolyzer 5 in a controlled manner with a predetermined maximum quantity of urine by pumping, followed by a step of ultrasonic treatment of the electrolyzed urine coming from the electrolyzer.

Of course, when the inlet 3 of the circuit 2 of the installation is equipped with a urine collector 10 in the form of a feces/urine separator, the step of supplying the electrolyzer 5 with liquid from the buffer tank 7 is preceded by a step of separating urine and feces.

It is recommended to occasionally clean the installation as described above. To this end, it is sufficient to fill the buffer tank 7 with a cleaning solution, to manually control the pump 9 to supply the electrolyzer, to use the pumping device 20 of the electrolyzer to clean the two compartments of the electrolyzer, and to optionally supply some of the cleaning solution to the ultrasound generator 6. By reversal of the direction of the pump 9, the contents of the electrolyzer 5 can be returned to the buffer tank 7, which can be drained. It is therefore not necessary to access the electrolyzer 5 and carry out any dismantling in order to clean it.

1. A urine treatment installation comprising:
a control unit and a fluid circulation circuit with at least one inlet for supplying urine to the circuit and with at least one outlet from said circuit, said installation comprising, disposed on said circuit, at least one electrolyzer equipped with at least one liquid outlet, and a tank serving to supply urine to the electrolyzer and having the function at least of a buffer tank in order to permit “batchwise” operation, that is to say batch feeding of the electrolyzer from said buffer tank, said buffer tank, in fluidic communication with the electrolyzer, being connected to the electrolyzer by at least one connection equipped with a pump capable of being controlled by the control unit,
wherein the installation comprises an ultrasound generator positioned downstream of the electrolyzer and in fluidic communication with the or at least one of the liquid outlets of the electrolyzer, in that the ultrasound generator comprises a chamber and an ultrasonic nebulization apparatus housed inside said chamber, in that said chamber is equipped with at least one device for forced circulation of fluid, at least one outlet to ambient air and at least one liquid inlet in fluidic communication with the or at least one of the liquid outlets of the electrolyzer for supplying electrolyzed liquid urine to said chamber, in that said nebulization apparatus is configured to transform at least some of the electrolyzed liquid urine from the electrolyzer into a mist-like cloud of fine particles, and in that the device for forced circulation of fluid is configured to guide the movement of the produced mist in the direction of the or at least one of the outlets to ambient air of said chamber, and in that the pump of the connection between the buffer tank and the electrolyzer is a reversing pump.

2. The urine treatment installation as claimed in claim 1, wherein the electrolyzer is compartmentalized and comprises a first compartment housing electrodes and equipped with the liquid outlet of the electrolyzer, and a second compartment communicating with the first compartment on the one hand via an overflow and on the other hand via a pumping device.

3. The urine treatment installation as claimed in claim 1, wherein the electrolyzer comprises a level sensor, and in that the control unit is configured to control the reversing pump at least as a function of the data provided by the level sensor.

4. The urine treatment installation as claimed in claim 3,
wherein the electrolyzer is compartmentalized and comprises a first compartment housing electrodes and equipped with the liquid outlet of the electrolyzer, and a second compartment communicating with the first compartment on the one hand via an overflow and on the other hand via a pumping device, and
wherein the control unit is configured to control the pumping device as a function of the data provided by the level sensor.

5. The urine treatment installation as claimed in of claim 1, wherein the electrolyzer is equipped with at least one gas outlet connected to the ultrasound generator.

6. The urine treatment installation as claimed in of claim 1, wherein the inlet for supplying urine to the circuit is equipped with a urine collector.

7. The urine treatment installation as claimed in claim 6, wherein the urine collector is a urinal or a feces/urine separator with a urine-collecting part and a feces-collecting part.

8. The urine treatment installation as claimed in claim 7, wherein the installation comprises a feces treatment unit.

9. The urine treatment installation as claimed in claim 8, wherein the feces treatment unit comprises a dihydrogen production station connected at the inlet to the electrolyzer in order to enable electrolyzed urine to be supplied to the dihydrogen production station, and a feces combustion station operating on dihydrogen, that is to say comprising at least one dihydrogen burner, said feces combustion station being equipped with a connection connecting the feces combustion station to the feces-collecting part without passage through the electrolyzer.

10. The urine treatment installation as claimed in of claim 1, wherein a non-return valve is arranged on the outlet to ambient air of the ultrasound generator.

11. The urine treatment installation as claimed in of claim 1, wherein the electrolyzer and the ultrasound generator are housed inside a casing.

12. A method for treating urine in a urine treatment installation, wherein the urine treatment installation is in accordance with claim 1, said method comprises, starting from the buffer tank, a step of supplying urine in a controlled manner to the electrolyzer by pumping, followed by a step of ultrasonically treating the electrolyzed urine coming from the electrolyzer.

13. The method as claimed in claim 12, wherein the inlet of the circuit of the installation is equipped with a urine collector in the form of a feces/urine separator, with a urine-collecting part and a feces-collecting part, the step of supplying urine to the electrolyzer from the buffer tank being preceded by a step of separating the urine and feces.
